(19) United States
(12) Patent Application Publication
(10) Pub. No.: US 2019/0137403 A1
(43) Pub. Date: May 9, 2019

(54) HANDHELD ANALYZER AND METHOD FOR MEASURING ELEMENTAL CONCENTRATION

(71) Applicant: IPG PHOTONICS CORPORATION, Oxford, MA (US)

(72) Inventors: Valentin GAPONTSEV, Worcester, MA (US); Ivan KURATEV, Moscow (RU); Roman BIRYUKOV, Moscow (RU); Ekaterina FEDYNA, Moscow (RU); Sergey PASHKO, Moscow (RU); Oleg MELOVATSKY, Moscow (RU); Andrey REZNIKOV, Moscow (RU); Nadezhda KOVYZHENKO, Moscow (RU); Dmitri OULIANOV, Moscow (RU)

(21) Appl. No.: 16/092,985

(22) PCT Filed: Apr. 11, 2017
(86) PCT No.: PCT/US17/27007

§ 371 Date: Oct. 11, 2018

Related U.S. Application Data
(60) Provisional application No. 62/320,997, filed on Apr. 11, 2016.

(51) Int. Cl. G01N 21/71; G01J 3/443; H01S 3/16; H01S 3/11; H01S 3/109; H01S 3/0941; H01S 3/067; H01S 3/094

(52) U.S. Cl. CPC G01N 21/718; G01J 3/443; H01S 3/1618; H01S 3/1115; H01S 3/109; H01S 3/0941; G01N 2201/06113; H01S 3/1623; H01S 3/06712; H01S 3/094042; G01N 2201/0221; G01N 2201/105; H01S 3/1643

(57) ABSTRACT

The disclosed method and handheld analyzer of elemental concentration measurement is based on spectral analysis of high temperature highly ionized plasma generated by laser-generated pulses. Due to a high pulse energy and short pulse duration, high intensity singly and multiply charged ion lines in addition to neutral atomic lines are excited. The pulsed laser source of the disclosed analyzer is configured to output a train of pulses of signal light at a 1.5-1.6 signal wavelength at a pulse repetition rate from 0.1 to 50 kHz, pulses duration from 0.01 to 1.5 ns, pulse energy between 100 and 1000 uJ and has a beam spot on the surface of the sample varying 1 to 60 μm. The above-described parameters provide at least a 20 GW/cm² laser power density sufficient to induce a high temperature, highly ionized plasma (plasma) which allows measuring the carbon concentration in carbon steels by employing doubly charged ionic line CII with a detection limit down to 0.01% and other elements commonly present in carbon steels with detection limit below 0.01%.

### BACKGROUND OF THE DISCLOSURE

### 1. Field of the Disclosure

The present invention relates to laser induced breakdown spectroscopy. More particularly, the invention relates to a method of elemental concentrations measurement based on laser-induced breakdown spectroscopy of high temperature highly ionized plasma with a handheld device.

### 2. Prior Art

Handheld analyzers of chemical elemental composition are very popular tools as they are able to provide field express quantitative analysis of materials. Currently there are two alternative technologies used in most commercially available handheld devices: x-rays fluorescence (XRF) and laser breakdown spectroscopy (LIBS).

The XRF method is based on detection of characteristic fluorescence spectrum in the x-ray region excited by keV x-ray radiation. Even though XRF technology has a higher level of maturity and more commonly used, it has two major drawbacks: it cannot detect elements with Z below 12, and it uses hazardous ionizing radiation.

LIBS method utilizes high energy laser pulses focused into a sample surface producing plasma plume which irradiates characteristic atomic and ionic spectra in UV, visible and near IR spectral region. These spectra are measured and analyzed providing quantitative information on the elemental composition of the sample. LIBS method can be used to measure concentrations of elements from hydrogen (H) to uranium (U). Concentrations of most elements can be determined with low detection limits (down to 10 ppm).

There are elements, however, such as carbon (C), which are difficult to measure inside iron (Fe) alloys because C emission lines are masked by Fe matrix and non-carbon impurities-related signal. Currently, the majority of Fe alloys manufactured in the world are carbon steels, with the carbon concentration being a crucial parameter for material properties. Thus C concentration measurement with detection limit of better than 0.05% is very important for many industrial applications. There is a significant demand for a handheld analyzer that can measure C concentration in steels. Commercially available handheld analyzers based on both XRF and LIBS either cannot detect C or offer quite high detection limits for Fe alloys, and therefore they cannot be used for that task.

The conventional LIBS approach employs 10s mJ energy 1-10 nanosecond (ns) pulses for plasma generation. However, this approach is not without certain disadvantages. First of all, mJ level lasers have usually low repetition rates of 1-20 Hz. Such a low repetition rate limits the number of averaging per measurement, which in turn limits the improvement of signal to noise ratio. Another drawback is that mJ pulse generates plasma in quite a large volume, which is associated with the reabsorption of some emission lines (especially ionic lines) and significant decrease of detected intensity of these lines.

Still another disadvantage of the conventional LIBS stems from the fact that the regime of plasma generation is accompanied by a strong signal from the electron continuum which masks the elemental emission lines. In order to solve the masking problem one has to use stroboscopic or gated detection which helps decrease continuum contribution. Regrettably, the stroboscopic or gated detection also decreases the usable amount of detected emission light.

The detection sensitivity may be improved by the increase of pulse energy and pulse shape manipulation (e.g. by having double pulse excitation). The 1 ppm detection limit of carbon has been demonstrated with a 100 mJ double-pulsed laser, but its overall dimensions far exceed all reasonable sizes for handheld devices.

The maximum pulse energy up to date realized in a handheld analyzer is 6 mJ with pulse duration of 1 ns and 10-50 Hz repetition rate (Z line of LIBS handheld analyzers by SciAps, Inc). It was reported that the Z-500 analyzer could measure C concentration by analysis of DUV 193 or 175 nm CI atomic lines. Because of strong DUV light absorption by air at wavelengths below 200 nm, inert gases, such as argon (Ar), was used.

Another approach used in several commercial handheld LIBS element analyzers includes using 1-2 nanosecond pulses emitted at a 1-5 kHz repetition rate and delivering 10 to 30 uJ energy. In that case very strong focusing is used. These parameters usually lead to lower temperature of plasma which makes some of the ionic emission lines not present in the spectrum.

In addition to the ability to reliably measure elemental concentrations in materials LIBS-based handheld analyzers should also have the following features: they should be light and compact enough to be operated by one hand; laser radiation used is preferred to be in the eye-safe wavelength range; laser should be of class I; analyzer should be low maintenance and easy to use, it is preferred to use no purging gas.

### SUMMARY OF THE DISCLOSURE

The disclosed method and handheld analyzer of elemental concentration measurement based on spectral analysis of high temperature highly ionized plasma generated by laser pulse overcome certain disadvantages of the known methods and devices. The disclosed handheld analyzer includes a pulsed laser source configured to excite high intensity singly and multiply charged ion lines in addition to neutral atomic lines. The analyzer is specifically configured with a group of system parameters allowing for high signal to noise ratio which significantly decreases the limit of detection and provides a high degree of precision of element concentration measurements. The use of the disclosed handheld analyzer allows providing the quantitative analysis of elements from hydrogen (H) to uranium (U) in solid state materials which includes plastics, dielectrics, and transparent samples. One of the most attractive features of the handheld analyzer is its structure that provides field concentration analysis of carbon steels and steel grade determination down to and even below 0.01%.

In accordance with one aspect of the disclosure, the handheld analyzer includes a high energy pulsed laser source emitting a laser beam with a Gaussian (TEMoo) intensity profile at a signal light wavelength varying in a 1.5-1.6 nm range. The energy delivered by pulses is high enough to generate plasma on the surface of the material to be analyzed. The disclosed analyzer further includes a scanner sweeping the laser beam across the desired zone of the material, at least one spectrometer and system for processing the detected data.

Another aspect of the disclosed handheld analyzer of the first aspect is concerned with optimization of system parameters generating plasma which leads to the increased detected intensity of singly and multiply charged ionic lines. The system parameters include a pulse energy, pulse duration, focus waist diameter, focus position scanning regime, laser pulse repetition rate, and spectrometer resolution. The optimized structure of the handheld analyzer significantly decreases limit of detection and improves precision of element concentration measurement by a handheld device

In accordance with this aspect, the pulsed laser source is configured to output pulses in a 0.01-1.5 ns wavelength range at a repetition rate of 0.1-50 kHz. The pulses each are characterized by a pulse energy varying between 50 and 1000 uJ. The focused laser beam has a beam waist diameter ranging from 1 to 60 μm on the irradiated surface of the material to be processed.

In a further aspect of the disclosure, the pulse energy of the laser source of any of the above-disclosed aspects is so high that a strong signal-to-noise ratio eliminates the need for a complicated gating system. The spectrometer of the handheld analyzer is operative to maintain a 1 to 200 picometer (μm) resolution range in a 170-800 nm spectral range.

The handheld analyzer of any of the above-discussed aspects has been particularly useful in optimizing the plasma generation when configured to output 0.3.-0.4 ns pulses at a repetition rate of 2-5 kHz, and pulse energy of 100 uJ. The analyzer so configured outputs a Gaussian beam having a 50 um waist diameter on the sample surface, and has a spectral resolution of 0.1 nm in the range of 200-400 nm. The 200-400 nm spectral range is particularly suitable for non-gated detection of elements that are commonly present in carbon steels.

In a further aspect of the disclosure, the handheld analyzer of any of the above-disclosed aspects is configured with the scanner that manipulates the laser beam so that, while irradiating the desired zone of the sample, the beam is incident on the same location within the zone only once. In other words, the pulses are never overlapped on the surface of the sample.

The scanner of any of the above-disclosed aspects is configured with multiple electromotors each having a shaft with an eccentric mounted thereon. The motors are coupled to a beam expander, such as a telescope, to apply a wobbling motion to the output lens of the telescope in a manner that prevents irradiation of the same location on the sample twice.

In a further aspect, of the handheld analyzer of any of the above disclosed aspects is operative to detect a carbon concentration in carbon steels measured by employing doubly charged ionic line CIII 229.687 with detection limit down to and below 0.01%.

The disclosure is also related to a method for measuring elemental concentration by means of the handheld analyzer disclosed in each of the above discussed aspects and any possible combination thereof.

### BRIEF DESCRIPTION OF THE DRAWINGS

The disclosure is further described below in detail in the specific description accompanied by the following drawings, in which:

FIG. 1 is a view of the disclosed handheld elemental analyzer;

FIG. 2 is a block diagram of the handheld elemental analyzer of FIG. 1;

FIG. 3 is a view of the handheld analyzer of FIG. 1 with a partially removed housing.

FIG. 4 is an optical schematic of the laser source of the handheld analyzer of FIG. 1.

FIG. 5 is a view of the scanner unit of the handheld elemental analyzer of FIG. 1.

FIG. 6 is a diagrammatic view of one of the embodiments of the scanner of FIG. 4.

FIG. 7 is an emission spectrum of carbon steel sample with 0.45% of C after Fe matrix background subtraction.

FIG. 8 is a CIII 229.687 nm line intensity vs carbon concentration (ratio of C to Fe mass) for 4 carbon steel certified standard samples.

FIG. 9 is a computer generated image of the pulse emitted by the disclosed handheld elemental analyzer.

### SPECIFIC DESCRIPTION

Reference will now be made in detail to the disclosure. Wherever possible, same or similar reference numerals are used in the drawings and the description to refer to the same or like parts or steps. The drawings are in simplified form and are not to precise scale. The computer generated images The term “couple” and similar terms do not necessarily denote direct and immediate connections, but also include connections through intermediate elements or devices.

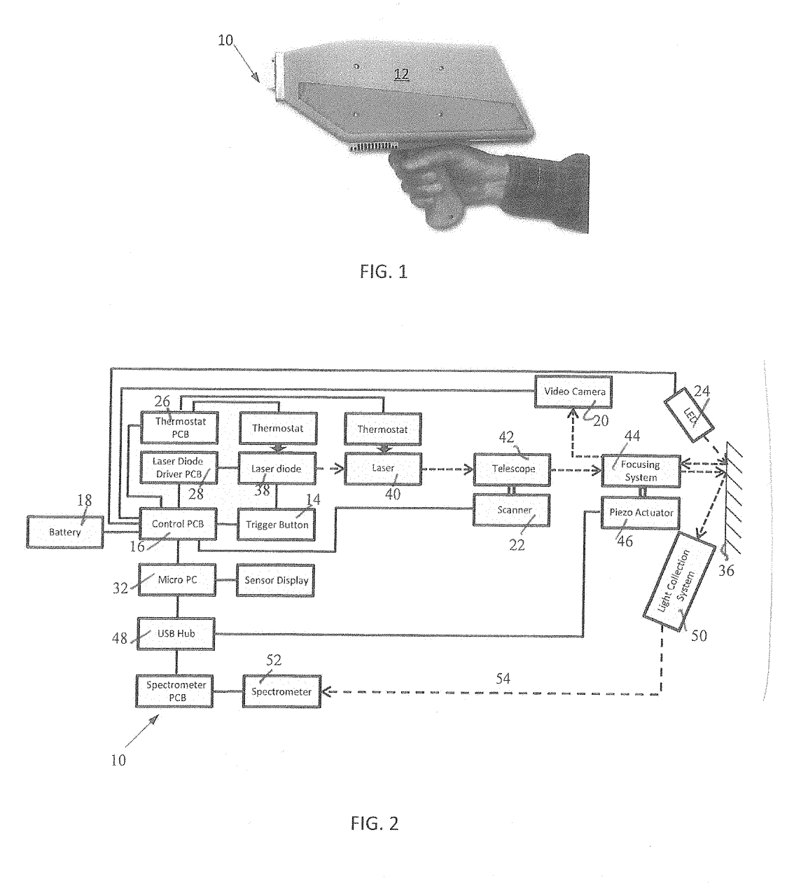

Conceptually, in order to increase sensitivity of elements detection the regime of plasma generation is optimized by the disclosed analyzer of FIGS. 1-6. The optimized plasma increases the detected intensity of singly and multiply charged ionic lines.

Referring particularly to FIG. 1, the disclosed analyzer 10 is packaged in a housing 12 encasing multiple components, as disclosed below, and weights about two (2) kilograms. The analyzer 10 is configured with a 1M class laser source operating in an eye safe wavelength range of 1.5-1.6 um.

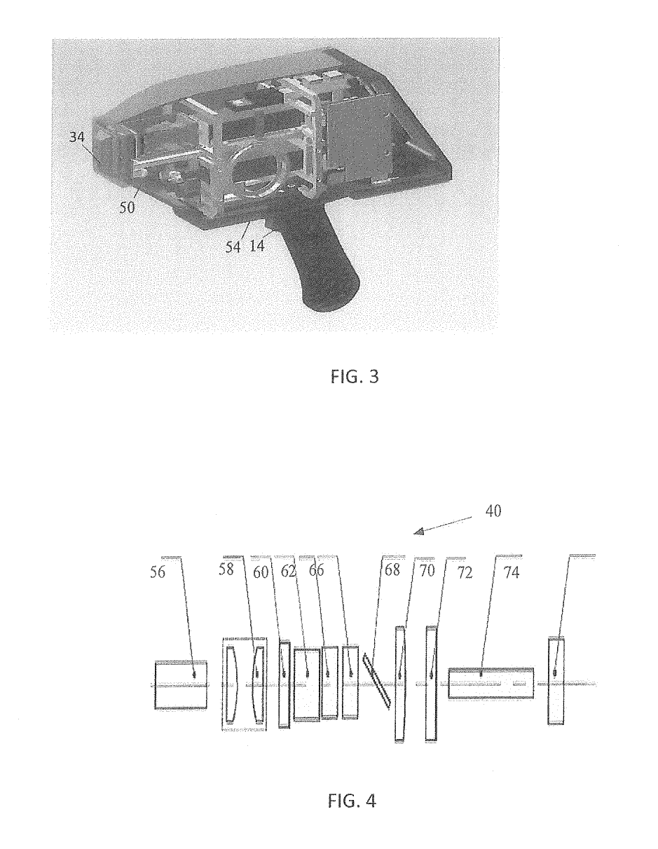

FIGS. 2 and 3 illustrate a block-diagram of and partially open analyzer 10 which operates in the following manner. Turning in particular to FIG. 2, a process control block (PCB) 16 is energized by a battery 18 and is in direct electrical communication with a video camera 20, scanner unit 22, light source 24, thermostat PCB 26, lased pump diode PCB 28, laser trigger button 14 and microprocessor 32.

Once analyzer 10 is ready to operate, an endpiece 34 (FIG. 3) 0 of analyzer 10 is brought into a surface-to-surface contact with a surface 36 (FIG. 2) of sample to be analyzed. Thereafter, the user pushes trigger button 14 to energize a laser pump diode or diodes 38 of FIG. 2 emitting multimode sub-pump light at wavelength within a 930-950 nm. The sub-pump light is coupled into a pulsed laser 40 outputting pulsed radiation—signal light—in a substantially single mode at a wavelength ranging between 1050-1060 nm. The signal light is further guided through a beam expander or telescope 42 and thereafter through a focusing lens system 44 which is configured to focus the signal light on surface 36 of the sample.

The desired beam spot on surface 36 is realized by displacing focusing system 44 by a piezo actuator, which receives the signal from microprocessor 32 via an USB hub 48. The focusing system 44 is guided along the direction of propagation of the signal light towards and away from surface 36.

While beam focusing, scanner unit 22 is activated to provide telescope 42 with a motion resulting in angular displacement of the signal light. As the signal light sweeps a zone on surface 36, an auto-focusing system operates so that regardless of the angular position of the signal light, it has the desired beam spot within the zone.

During the irradiation of the surface, the zone, swept by the signal light, is illuminated by light source 24, which is typically configured as a single or multiple light emitted diodes (LED). The whole process is screened by video camera 20.

The radiation of the generated high temperature highly ionized plasma is collected by a light collected system 50 which couples the collected plasma into one or more fiber waveguides 54 (FIG. 3). The latter guide the collected plasma light to one or more spectrometers 52 analyzing the delivered radiation in a known manner. The results of spectro-analysis are further quantified and quantified.

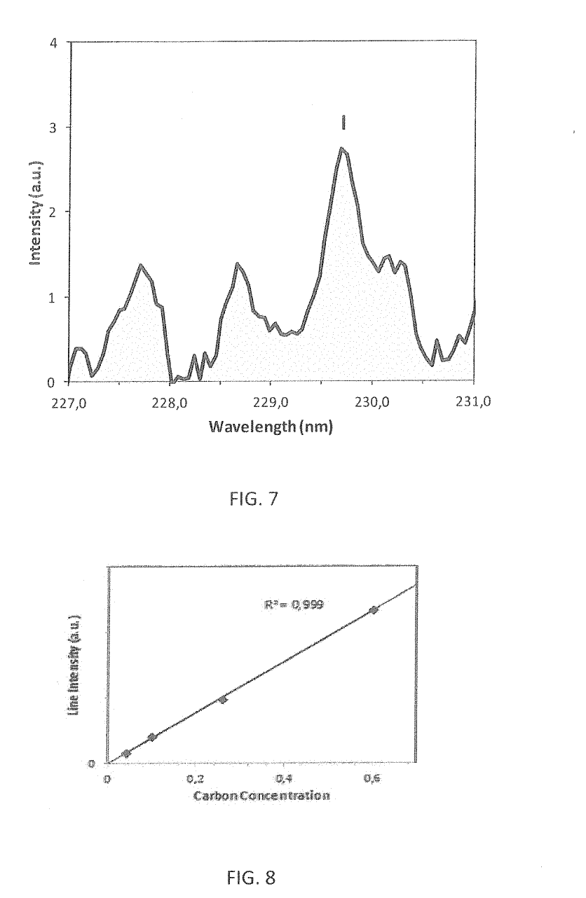

The optimization of system parameters leads to such as high temperature plasma that a carbon concentration in carbon steels can be measured by employing doubly charged ionic line CIII 229.687, as shown in FIG. 7, with detection limit down to 0.01% which is believed was not possible to see by the known portable analyzers. FIG. 8 shows the dependence of CIII 229.687 nm line intensity on carbon concentration measured in 4 carbon steel certified standard samples. The linear fit is also shown. Determination coefficient R² of a linear fit equals to 0.999.

In particular, analyzer 10 capable of generating the critical plasma is configured to output a train of pulses at a pulse repetition rate of 2-5 kHz. Each pulse is output with width a 0.3-0.4 nm pulse width and pulse energy of 100 uJ and forms a 50 um Gaussian beam waist diameter on the sample surface. With the generated plasma the analyzer is operative provide non-fated detection with a spectral resolution of 0.1 nm in a 200-400 nm wavelength. Critical to the desired operation of analyzer 10 is a beam scanning regime allowing plasma generation from a fresh spot with every pulse.

The combination of sub-nanosecond pulse duration, 100 uJ pulse energy and tight focusing leads to ˜20 GW/cm² laser power density on the surface. In addition, compared to longer pulses, the optimized pulse duration provides lower heat dissipation from the excited zone and therefore leads to higher temperature plasma. The plasma generated under these conditions has strong ionic lines and suppressed electronic continuum, therefore gated detection is not needed. The 100 uJ pulse energy, non-gated detection and high pulse repetition rate provide a sufficiently high total photon flux on the detector under 1 sec measurement times. The generation of plasma with a single pulse single pulse and the above-disclosed beam scanning regime allow the signal light to be always focused on the sample. The spectral resolution of 0.1 nm used was good enough for line separation for most elements. In particular, the measurement of concentrations of other elements commonly present in carbon steels and including Si, Mn, Cr, Ni, Mo, Ti, V, Cu, Al can be done with detection limits for these elements below 0.01%. The wavelength range of 200-400 nm is suitable for elements which are common in carbon steels, whereas a larger wavelength range from 170 to about 800 nm is required for more versatile analysis of all elements from H to U. No purging gas is needed when the inventive analyzer is in use.

The capability of analyzer 10 to detect the CIII 229.687 nm line intensity is a product by, among others, laser 40 and a combination of scanner 22 and telescope 42. These components are discussed herein below in greater detail.

Referring to FIGS. 2 and 4 which illustrates the optical schematic of laser 40, the latter includes pigtailed pump laser diode 38 with a fiber support 56. The pump light at a 940 nm wavelength is emitted from fiber to propagate through a 2-lens condenser 58 and an input reflective element 60 which is transparent to the pump light incident on gain medium 62. The gain medium 62 includes an Yb:YAG crystal generating pump light in a 1020-1040 nm pump wavelength range. The input reflective mirror 60 defines a high reflectivity mirror of the pump laser which has a pump laser cavity defined between input mirror 60 and output mirror 64.

The formation of sub-nanosecond pulses is realized by placing in the pump laser cavity one or multiple optical absorbers (OA) 66 configured to mode-lock the laser in a manner well known to one of ordinary skills in the pulsed laser arts. Preferably, OA 66 is configured as a Cr:YAG crystal.

The pump light is not polarized and thus should be processed to acquire the polarization. One possibility of obtaining polarized light is to cut the Cr:YAG crystal in a known manner. The other possibility is to use a separate polarizer component 68. The polarized pump light at the 1030 nm wavelength is incident on a positive converging lens 70 focusing the polarized pump light in an intermediary mirror 72.

The intermediary mirror 72 and output coupler 64 define a resonator of optical parametric oscillator (OPO) having a nonlinear crystal 74. The nonlinear crystal 74 when pumped by the pump light at 1030 nm is configured to output pulses of signal light at a signal light wavelength, which is this schematic, varies between 1500-1600 nm. The crystal 74 can be selected from KTP, KTA, RTP, or RTA crystals and is cut for non-critical synchronism.

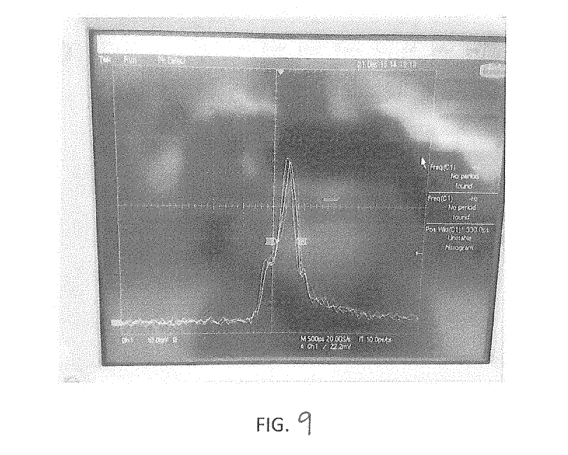

Returning to the resonator, intermediary mirror 72 is 100% reflective at 1500-1600 pump wavelength and fully transparent at the pump wavelength. The signal light is outcoupled from the resonator through output coupler 64 which is partially transparent at 1.5-1.6 μm wavelength (0.2-0.3% reflectivity) and 100% reflective at the 1030 nm pump wavelength. The light signal pulse is illustrated in FIG. 9.

The Yb:YAG crystal has certain advantages over Nd:YAG crystals. For example, Yb:YAG crystal generates lower hit by comparison with a Nd:YAG crystal. Another advantage of the Yb:YAG over Nd:YAG is its high power density which is necessary within the scope of this disclosure.

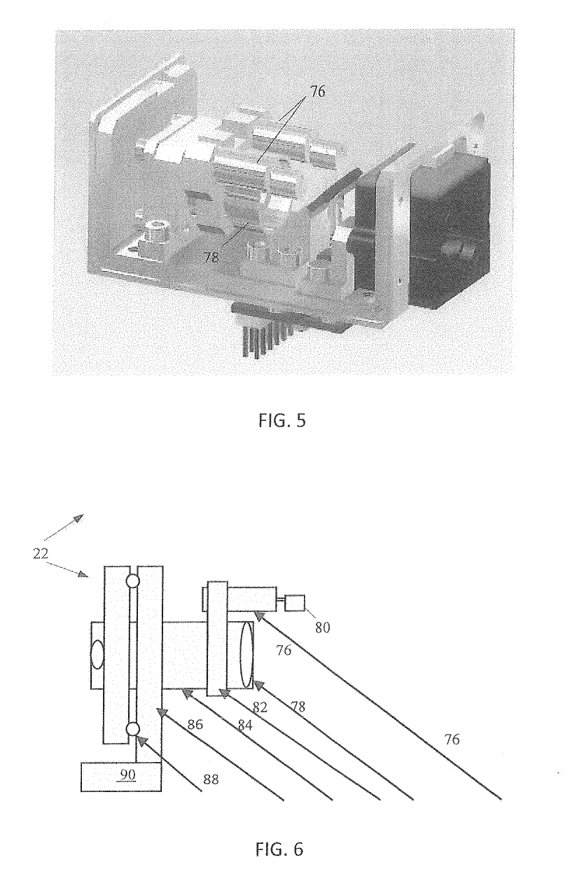

Referring to FIGS. 5 and 6, the scanner unit 22 in combination with the telescope is configured to enlarge the signal light beam, so that it can be tightly focused thereafter, and controllably deflect this beam over time so as to prevent pulses of signal light from overlapping on the surface of the sample to be analyzed. This advantages feature is realized by a structure in which eccentric motion of one or multiple electromotors 76 is translated to a lens 78 of telescope unit 42. As a result, while the endpiece of analyzer 10 is tightly pressed again the sample, lens 78 is angularly displaced thus guiding the signal light across a certain zone on the surface of the sample. Each pulse of signal light creates plasma within the zone while never irradiating the same location twice.

Turning specifically to FIG. 6, the scanner further includes a support 84 rigidly mounted to a frame 90 of the device. A cylindrical sleeve 84 of the telescope unit, housing beam expanding optics which includes lens 78, is mounted to support 86 by means of elastic ring 88. The latter is made from material, such as silicon, preserving its characteristics and shape regardless of environmental factors. The sleeve 84 is fixed to electromotor 76 by a cantilever 82.

The above disclosed kinematic scheme including sleeve 84, cantilever 83 and motor 76 is capable of being elastically displaced relative support 86 at a certain angle from its initial position in response to a force applied thereto. As the force is ceased, sleeve 84 returns to the initial position in response to a resilient force generated by elastic ring 88. Since laser 40 is displaceably fixed to frame 90, the laser beam does not move relative to support 86.

If the sleeve 84 is in its initial position, i.e., there is no scanning, the direction of the signal light coincides with optical axes of all optical components of the telescope while the laser beam remains in the same position. Once sleeve 84 is displaced at a certain angle, both the distance from the laser to the surface and angle of incidence of the beam change which leads to the deflection of the laser beam from its initial position.

The force displacing sleeve 84 is nothing else but an inertial force appearing during rotation of eccentric electromotor 76. This force is transferred from the motor's shaft through cantilever 82 to sleeve 84. As the constant voltage is applied to electromotor 76, the inertial force is also constant and sleeve 84 deflects at a constant angle. Under these conditions, the laser beam moves around a circle of a constant diameter which is defined by the applied voltage.

As the amplitude of applied voltage starts varying in time in accordance with a certain criterion, the magnitude of the deflection of the laser beam also changes in time. As a consequence, depending on the criterion, the displacement of the laser beam may have different trajectories, such as spiral, stepwise and others, within a circular zone formed on the surface of the sample.

Controllably changing the voltage depending on the repetition rate of emitted pulses of the signal light, it is possible to obtain uniform distribution of the laser beam on the surface of the sample across the area having the desired diameter.

Having described the disclosed analyzer and the method with reference to the accompanying drawings, it is to be understood that the disclosed structure is not limited to those precise implementation shown in the drawings, and that various changes, modifications, and adaptations may be effected therein by one skilled in the art without departing from the scope or spirit of the invention as defined in the appended claims.

1. A method of measuring elemental concentration by utilizing a handheld analyzer, comprising:
energizing a pulsed laser, thereby outputting a train of pulses at a pulse repetition rate from 0.1 to 50 kHz, with each pulse having duration from 0.01 to 1.5 ns and pulse energy between 50 and 1000 uJ;
focusing the laser beam onto a sample to be analyzed without the presence of inert gases, thereby generating a high temperature, highly ionized plasma which irradiates characteristic spectra in a desired wavelength range;
scanning the focused laser beam across a zone of the sample so as to generate the plasma at each location within the zone by a single pulse, thereby continuously focusing the laser beam on the sample; and
collecting plasma radiation in a spectrometer, thereby producing a signal output; and
processing the signal output, thereby measuring concentration of elements, which include carbon present in the sample, wherein a carbon concentration is measured in the generated plasma by using a doubly charged carbon ion spectral line in a wavelength range including 229.687 nm wavelength.

2. The method of claim 1, wherein the focused laser beam is substantially diffraction limited, emitted in a 1.5-1.6 μm wavelength range and has a beam spot on a surface of the sample in a 5 to 60 μm range.

3. The method of claim 1 or 2, wherein the at least one spectrometer has a resolution in a 1 to 200 picometer range in the wavelength range between 170 and 800 nm.

4. The method of claim 1, wherein the elements present in the sample include carbon steels, the carbon concentration in carbon steels being measured with a detection limit of about 0.01%, while concentration of other elements typically present in the carbon steels is measured with a detection limit below 0.01%, the other elements including Si, Mn, Cr, Ni, Mo, Ti, V, Cu and Al, the method further comprising determining a steel grade.

5. The method of claim 1 further comprising displaying the results of the measurements of elemental concentrations.

6. The method of claim 1 further comprising auto-focusing the focused laser beam while scanning.

7. A handheld analyzer of elemental concentration measurement without the use of purging gases, comprising:
a pulsed laser source configured to output a train of pulses of signal light at a signal wavelength at a pulse repetition rate from 0.1 to 50 kHz, wherein the pulses of light signal each have duration from 0.01 to 1.5 ns and pulse energy between 50 and 1000 uJ;
a focusing lens or lens combination impinged upon by each pulse and controllably displaceable along a propagation path to focus pulses of signal light to a focal spot at a sample so as to laser induce a high temperature, highly ionized plasma which irradiates characteristic spectra, wherein the focal spot varies in a 5 to 60 μm range;
a scanner configured to sweep the focused beam across a surface of the sample so as to generate the plasma at each irradiated surface location by a single pulse;
at least one spectrometer configured to receive light from the plasma, produce information describing the spectra and generate a signal output; and
a processor for processing the signal output, thereby measuring concentration of elements including carbon present in the sample, wherein the carbon concentration is measured in the generated plasma by using a doubly charged carbon ion line in a wavelength range including 229.687 nm wavelength range.

8. The handheld analyzer of claim 7, wherein the laser source includes
a passively Q-switched laser comprising:
an ytterbium (Yb)-doped solid state gain-medium outputting pump light at a fundamental wavelength and provided with an input mirror highly reflective at the fundamental wavelength;
an output coupler highly reflective at the fundamental wavelength and defining a laser cavity for the fundamental light with the input mirror;
a saturable absorber configured to generate the pulses of the pump light and located in the laser cavity between the input mirror and output coupler; and
an optical parametric oscillator (OPO) located next to the saturable absorber and configured with a resonator which is defined between the output coupler and a second mirror transparent at the fundamental wavelength, the OPO having an nonlinear crystal arranged within the resonator to frequency-convert the fundamental light to the signal light at the signal wavelength which is longer than the fundamental wavelength, wherein the second mirror is highly reflective at the signal wavelength while the output coupler is partly transparent at the signal wavelength.

9. The handheld analyzer of any of claim 7 or 8 further comprising a pump source pumping the Yb-doped solid state gain-medium at sub-pump wavelength ranging between 930 and 950 nm, the Yb-doped solid state medium including an Yb:YAG crystal which operates at the fundamental wavelength in 1020-1040 nm range, the optical absorber being a Cr:YAG crystal, and the nonlinear crystal being non-critically matched KTP, KTA, RTP, or RTA generating the signal wavelength ranging between 1500-1600 nm.

10. The handheld analyzer of any of claim 7, wherein the saturable absorber is Cr:YAG crystal having a 110° cut to polarize the fundamental wavelength when bleached.

11. The handheld analyzer of of claim 7 further comprising a beam expander-scanner unit impinged upon by the signal light which is expanded at a beam expander output including;
beam expander tube comprising optical components,
at least one electromotor mounted on the beam expander tube having a shaft rotatable about an axis,
an unbalanced (eccentric) weight mounted on the shaft to cause an angular displacement of the motor relative to the axis,
a stationary mount fixed to the laser chassis,
an elastic coupler located between the stationary mount and the beam expander tube, wherein the beam expander tube changes its angular position with respect to the laser output beam axis resulted in beam direction change according to the electromotor input voltage value.

12. The handheld analyzer of claim 11, wherein the pattern of scanning is a function of voltage applied to the motor and time of the voltage application.

13. The handheld analyzer of claim 12, wherein the pattern provides even distribution of focal spots on the surface.
